(19) United States
(12) Patent Application Publication
(10) Pub. No.: US 2015/0145260 A1
(43) Pub. Date: May 28, 2015

(54) INDUCTION GENERATOR

(71) Applicant: Shun-Fu Technology Corp., Taipei City (TW)

(72) Inventors: Yung-Sheng HUANG, Taipei City (TW); Shun-Hua LEE, Taipei City (TW)

(73) Assignee: Shun-Fu Technology Corp., Taipei City (TW)

(21) Appl. No.: 14/156,696

(22) Filed: Jan. 16, 2014

(30) Foreign Application Priority Data
Nov. 25, 2013 (TW) 102222004

(51) Int. Cl. H02K 3/28; F03G 7/00; F03B 13/00

(52) U.S. Cl. CPC H02K 3/28; F03B 13/00; F03G 7/00
USPC 290/1 R; 310/208; 290/52

(57) ABSTRACT

An induction generator is disclosed. When a magnetic field of a magnet acts upon a magnetic permeability material of non magnetism, the magnetic permeability material is magnetized to produce opposite poles, causing the magnetic permeability material and the magnet to attract each other and to generate a magnetic attractive force. A rotor is provided for movement relative to the magnetic permeability material subject to the effect of magnetic attraction. The rotor is formed of multiple magnets. Each magnet has opposing N pole and S pole. Coil windings are arranged around the rotor in a non-coaxial relationship and spaced from one another. The coil windings are mounted on the perimeter of a positioning member. An instantaneous current is obtained subject to the coil winding moving direction and the direction of magnetic field of the rotor. Each coil winding has a current input lead wire and a current output lead wire respectively disposed reversed to the direction of the instantaneous current. Thus, the induction generator can induce enhanced voltage and current, and has a wide range of applications.

### BACKGROUND OF THE INVENTION

1. Field of the Invention

The present invention relates to power generating technology and more particularly, to an induction generator. During movement of a magnetic permeability material, the magnetic field of rotor magnets is acted upon the magnetic permeability material, causing the magnetic permeability material to be magnetized, producing opposite poles, and thus the magnetized magnetic permeability material and each rotor magnet attract each other, causing movement of the rotor magnets to cut across the magnetic lines of force and to further induce electricity. Subject to arrangement of different coil windings, the invention greatly reduces the cost of the induction generator, improves the induced voltage and current, and widens the range of applications of the induction generator.

2. Description of the Related Art

A power generator generally comprises a rotor and a stator. Through the rotation of the rotor and the effect of the outer coin windings to cut across the magnetic lines of force, electromotive force and current are induced. This kind of conventional power generator needs a power drive (such as motor) to rotate the rotor.

In the aforesaid conventional power generator, there is a direct contact between the power drive and the rotor. Normally, a transmission gear, gear chain, or vane is connected between the power drive and the rotor for enabling the power generator to generate the desired electromotive force and current. Under the limitation of “direct contact” linking between the power drive and the rotor, the application range of this kind of power generator is limited.

Taiwan Patent 101122910 (WC2013004320A1), invented by a German company and issued on Feb. 1, 2013, discloses a contactless power generator, entitled “Device for contactless power generation, in particular bicycle dynamo, vehicle lighting system and bicycle”. This design of contactless power generator gets rid of the limitation of an external power drive.

The device of the aforesaid Taiwan Patent 101122910 (WC2013004320A1) is comprised of at least a movably arranged rotor element, which has at least a magnet, and at least a coil, the coil having at least a winding for inducing a current through the magnet when it is moved with the rotor element, and the current can be used for the consumption of electric devices to operate the same, wherein the rotor element is moved by alternate magnetic interaction with the counter element, characterized in that the rotor element and the counter element have different axes and the rotor element is positioned relative to a continuous circular rim and in an effective position to produce at least a eddy current based on magnetic fields in the conductive counter element, circular, in which a continuous relative motion between counter element and rotor element induces eddy current fields with current senses continuously alternate oppositely to each other in the counter element, based on the magnetic fields with opposite poles, and hence the rotor element is moved with counter element under a condition that an eddy current transmission is formed.

The power generator shown in FIG. 1 generally comprises a rotor 10 formed of a plurality of magnets and disposed in proximity to a wheel rim 11 of a magnetic permeability material, a coil winding 12 surrounding the rotor 10, and a frame 13 that holds the rotor 10 and the coil winding 12 in place. The magnetic lines of force of the magnets act upon the magnetic permeability material of the wheel rim 11 to induce eddy currents in the field opposite each other, thereby forming a rotating power source to rotate the rotor 10.

The aforesaid Taiwan Patent 101122910 (WC2013004320A1) “Device for contactless power generation, in particular bicycle dynamo, vehicle lighting system and bicycle” utilizes eddy currents to drive the rotor 10 to rotate. According to this design, the coil winding 12 is wound in radial direction around opposing top and bottom sides of the rotor 10. The number of windings is limited, affecting the induced amount of voltage and current. Subject to the winding arrangement of the coil winding 12, the number of magnets of the rotor 10 must be (2+n*4). Further, high grade magnets must be used for making the rotor 10 to generate sufficient electric energy for the consumption of an electric appliance of high power consumption. In consequence, the cost of the device for contactless power generation is high.

### SUMMARY OF THE INVENTION

The present invention has been accomplished under the circumstances in view. It is main object of the present invention to provide an induction generator, which effectively improves the induced voltage and current.

It is another object of the present invention to provide an induction generator, which has a wide range of applications.

It is still another object of the present invention to provide an induction generator, which greatly enhances the start up voltage of a high power consumption device.

It is still another object of the present invention to provide an induction generator, which allows the use of cheap rotor magnets without affecting the performance, thereby greatly reducing the cost.

To achieve these and other objects of the present invention, an induction generator of the present invention comprises a rotor rotatable relative to a predetermined magnetic permeability material subject to the effect of magnetic attractive force, the rotor comprising a plurality of magnets, each magnet having opposing N pole and S pole; a positioning member comprising a plurality of equiangularly spaced partition walls; a plurality of windings wound round the partition walls of the positioning member in a non-coaxial manner relative to one another; a direction of an instantaneous current obtained subject to the direction of movement of the coil windings and the direction of magnetic field of the rotor; wherein: each coil winding is configured to have a current input lead wire and a current output lead wire respectively disposed reversed to the direction of instantaneous current; each coil winding is also configured to have each wire segment thereof extending downward relative to the N pole of each magnet and upward relative to the S pole of each magnet.

In one embodiment of the present invention, the coil windings are formed of one single wire that is wound round one partition wall to form one coil winding, and then wound round another partition wall to form another coil winding, and then wound round the other partition walls to form the other coil windings in proper order.

In another embodiment of the present invention, the coil windings are formed of one single wire that is wound round the partition walls in a proper order through one turn, and then repeatedly wound round the partition walls in a proper order through another one turn, and then repeatedly wound round the partition walls in the same manner till that all the coil windings are respectively formed on partition walls.

Preferably, the winding directions of each two adjacent coil windings are reversed to each other.

Further, in one embodiment of the present invention, the positioning member is a stator disposed around rotor, and the partition walls are spaced around an outer perimeter of the annular stator and adapted to hold the coil windings in a non-coaxial manner relative to one another.

In another embodiment of the present invention, the positioning member is a coil winding rack arranged around the rotor, and the partition walls are equiangularly spaced around an inner perimeter of the coil winding rack and adapted to hold coil windings in a non-coaxial manner relative to one another.

Further, in one embodiment of the present invention, the magnets of the rotor are abutted against one another around a circle, defining therein a center hole, and the positioning member is mounted in the center hole defined in the rotor and surrounded by the magnets with the partition walls thereof arranged in an equiangularly spaced and radially extended relationship to hold the coil windings in a non-coaxial manner relative to one another.

In still another embodiment of the present invention, the rotor comprises a shaft disposed at the center thereof, wherein the shaft has a wire hole for enabling the current input lead wire and current output lead wires of the coil windings to be extended to the outside.

Further, the induction generator can be shaped like a strip and mounted at a bottom side of a carriage of a train near a rail on which the train is running.

Further, multiple induction generators of the same structure can be mounted in a wheel well of a fender of a magnetic permeability material near a wheel rim of a wheel of an electric motor vehicle, and electrically connected in parallel for recharging a battery of the electric motor vehicle.

Further, the induction generator can be mounted in a hydroelectric power generation equipment around a vane.

Other advantages and features of the present invention will be fully understood by reference to the following specification in conjunction with the accompanying drawings, in which like reference signs denote like components of structure.

### BRIEF DESCRIPTION OF THE DRAWINGS

FIG. 1 is a schematic structural view of a contactless power generating device according to the prior art.

FIG. 2 is a schematic drawing illustrating the arrangement of a rotor and coin windings in accordance with the present invention.

FIG. 3 illustrates an extended out status of the rotor and the winding of the coil windings shown in FIG. 2.

FIG. 4 explains the principle of the induction generator of the present invention, illustrating the direction of instantaneous current under the condition of known moving direction and direction of magnetic field.

FIG. 5 is a schematic drawing illustrating one winding example of the coil windings in accordance with the present invention wherein the rotor magnets are extended out.

FIG. 6 corresponds to FIG. 5, illustrating another winding example of the coil windings.

FIG. 7 illustrates an optimal winding of the coil windings for cutting across the magnetic lines of force in accordance with the present invention.

FIG. 8 is a schematic drawing illustrating still another winding example of the coil windings in accordance with the present invention.

FIG. 9 is a schematic structural view of an induction generator in accordance with a first embodiment of the present invention.

FIG. 10 is a schematic structural view of an induction generator in accordance with a second embodiment of the present invention.

FIG. 11 is a schematic structural view of an induction generator in accordance with a third embodiment of the present invention.

FIG. 12 is a schematic structural view of an induction generator in accordance with a fourth embodiment of the present invention.

FIG. 13 is an end view of FIG. 12.

FIG. 14 is a schematic structural view of an induction generator in accordance with a fifth embodiment of the present invention.

FIG. 15 is a schematic structural view of an induction generator in accordance with a sixth embodiment of the present invention.

FIG. 16 is a schematic structural view of an induction generator in accordance with a seventh embodiment of the present invention.

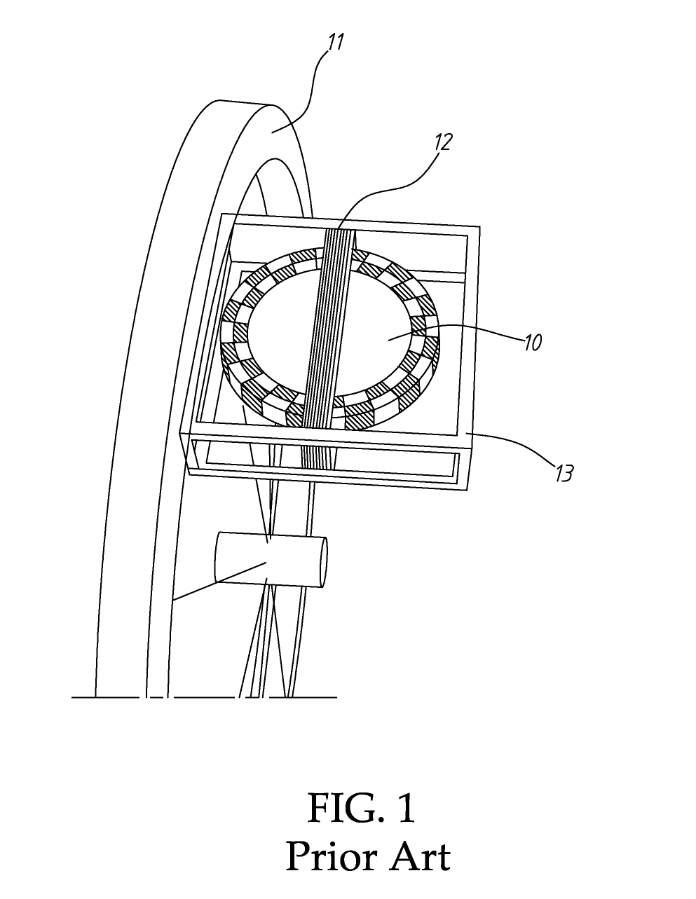

### DETAILED DESCRIPTION OF THE PREFERRED EMBODIMENT

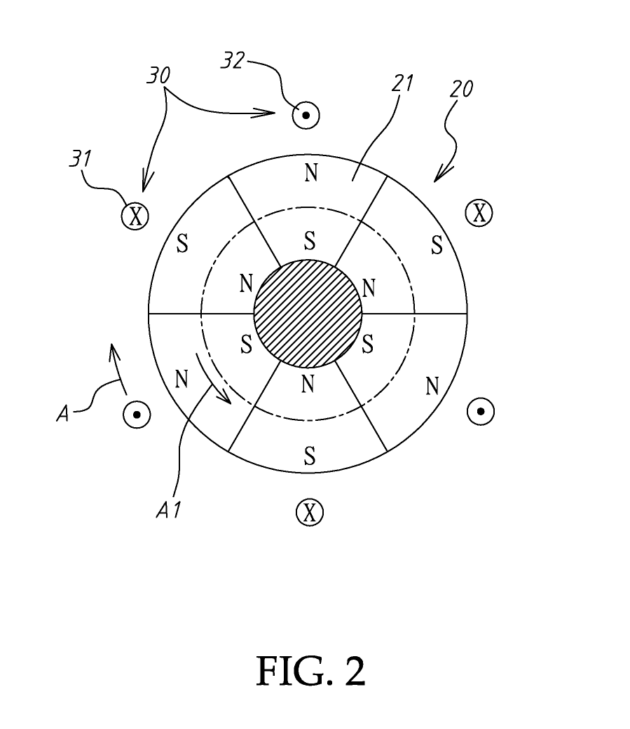

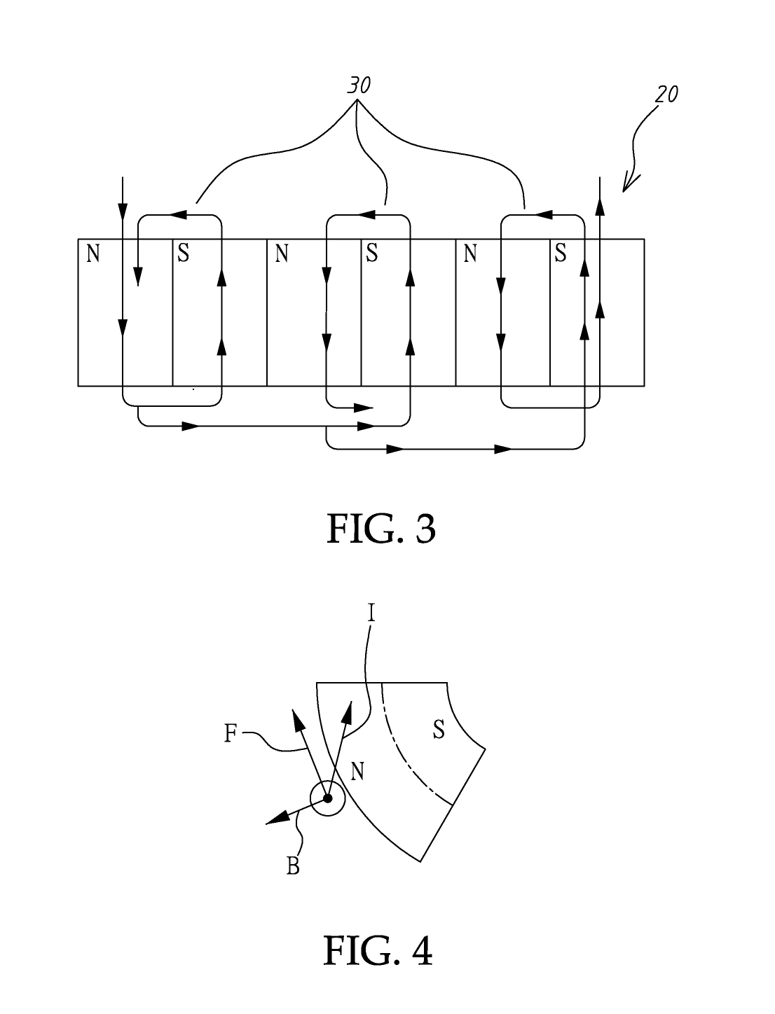

Referring to FIGS. 2 and 3, an induction generator in accordance with the present invention is shown. The induction generator comprises a rotor 20 rotatable relative to a magnetic permeability material (not shown) subject to the effect of magnetic attractive force, and a plurality of windings 30 spaced around the rotor 20 in a non-coaxial manner relative to one another. The rotor 20 consists of a plurality of magnets 21. Each magnet 21 has opposing N pole and S pole. The windings 30 can be wound round the perimeter of a positioning member, for example, stator (not shown). The said perimeter is not limited to the outer perimeter of the stator. For example, the perimeter can also be the inner perimeter of the stator. The winding direction A of each coil winding 30 is revered to the rotating direction Al of the rotor 20. Further, as shown in FIG. 4, if the moving direction F of the coil windings 30 and the direction of the magnetic field B of the rotor 20 are known, the direction of instantaneous current can be known, therefore each coil winding 30 is configured to have a lead wire 31 for current input and a lead wire 32 for current output, and each coil winding 30 is also configured to have the wire segments thereof extend downward relative to the N pole of each magnet 21 or upward relative to the S pole of each magnet 21.

Materials can be classified into magnetic materials and non-magnetic materials. The basic property of magnetism comes from the fact that electrons within an atom orbit the nucleus and form a current loop. Their action generates a magnetic field. Magnetism is a class of physical phenomena that includes forces exerted by magnets on other magnets. It has its origin in electric currents and the fundamental magnetic moments of elementary particles. These give rise to a magnetic field that acts on other currents and moments. Different magnetic materials exhibit different magnetization strength.

Subject to magnetization strength, magnetic media can be classified into diamagnetism (such as copper, silver . . . ), paramagnetism (such as aluminum, manganese . . . ), and ferromagnetism (such as iron, nickel . . . ). Diamagnetic materials can produce a repulsive force. Therefore, the aforesaid magnetic permeability material movable relative to the rotor 20 in this embodiment is selected from the group of paramagnetic materials, ferromagnetism materials and alloys of paramagnetic and ferromagnetic materials that are capable of producing a magnetic attractive force, for example, aluminum alloy ADC12.

Aluminum alloy ADC12 (Wt. %)

| | Si | Fe | Cu | Mn | Mg | Zn | Ni | Sn |
|---|---|---|---|---|---|---|---|---|
| % | 9.6~12 | 0.9 | 1.5~3.5 | 0.5 | 0.4 | 1.0 | 0.5 | 0.3 |

In the motion, the magnetic field produced by the rotor magnet is acted upon the magnetic permeability material, causing the magnetic permeability material to be magnetized, producing a different magnetic pole, thus, the rotor and the magnetic permeability material are caused to attract each other, driving the rotor magnet to make a relative motion and to further cut across the magnetic field lines in inducing an electromotive force.

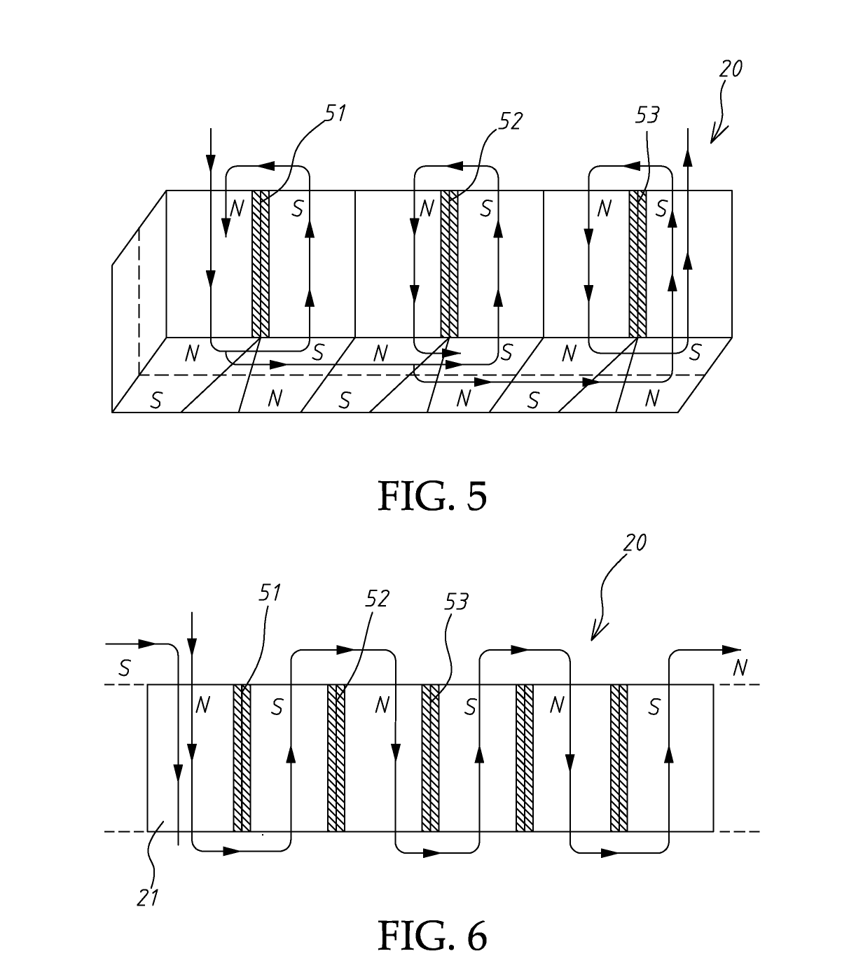

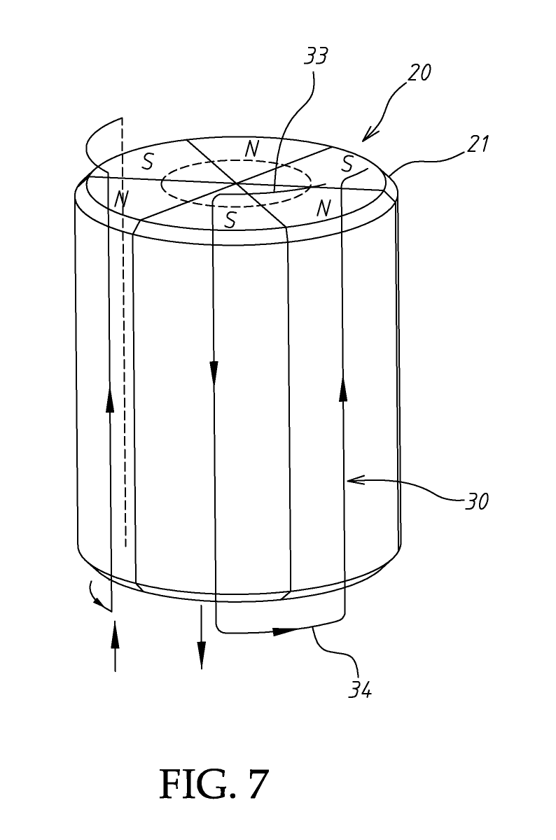

FIG. 5 is an extended-out view of the rotor 20, illustrating one winding method of the present invention. In this embodiment, the rotor 20 consists of 6 pcs of magnets 21. As illustrated, spaced partition walls 51, 52, 53 are mounted in the positioning member, i.e., the stator. An enameled wire is firstly wound round the first partition wall 51 to form one coil winding 30, and then wound round the second partition wall 52 and then the third partition wall 53 in a proper order. FIG. 6 illustrates another winding method of the present invention. According to this winding method, an enameled wire is wound round the partition wall 51 through one turn, and then extended to the second partition wall 52 and wound round the second partition wall 52 through one turn, and then extended to and wound round every other partition wall through one turn in proper order and then extended from the last partition wall back to the first partition wall 51 to repeat the winding through one turn, and this winding procedure is repeated again and again till that all the desired coil windings 30 are made. Referring to FIG. 7, because the coil winding 30 cut the magnetic field lines only in diameter direction, the transverse wire segments 33 and 34 at the opposing top and bottom sides of every coil winding 30 are preferably longer than the length of every magnet 21 of the rotor 20.

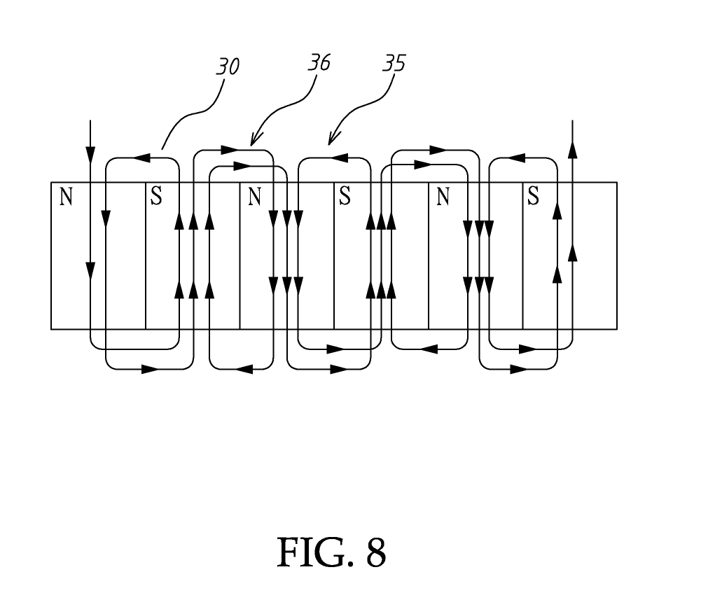

FIG. 8 illustrates still another winding method of the present invention. In this embodiment, the enameled wire winding direction of one coil winding 30 is reversed to the enameled wire winding direction of every adjacent coil winding 30, for example, the coil windings 30 at the odd number 1^{st}, 3^{rd}, 5^{th} partition walls are wound in counter-clockwise direction 35, and the coil windings 30 at the even number 2^{nd}, 4^{th}, 6^{th} partition walls are wound in clockwise direction 36.

The electromotive force (electric voltage) and current induced by the induction generator of the present invention can be affected by the following factors:

1. The voltage and current are induced upon cutting of the windings across the magnetic field lines, therefore the higher the density of the magnetic lines of force (magnetic flux) and the amount of change in the magnetic lines of force (magnetic flux) are, the greater the induced voltage and current will be.

2. The thickness of the enameled wire of the coil windings affect the number of turns and wire resistance of the coil windings and, thereby directly affecting the amount of the induced voltage and current.

3. The material, grade, size and amount of the rotor magnets affect the amount and frequency of the induced voltage and current.

4. If the magnetic permeability material of the shaft and bearings is magnetized, an additional magnetic field will be produced to increase the magnetic flux of the rotor magnets, affecting the amount of the induced voltage and current.

Subject to proper selection of the winding method, number of coil windings, wire diameter for coil winding, number of turns of coil windings and winding direction of coil windings, excellent voltage and current can be induced, as follows:

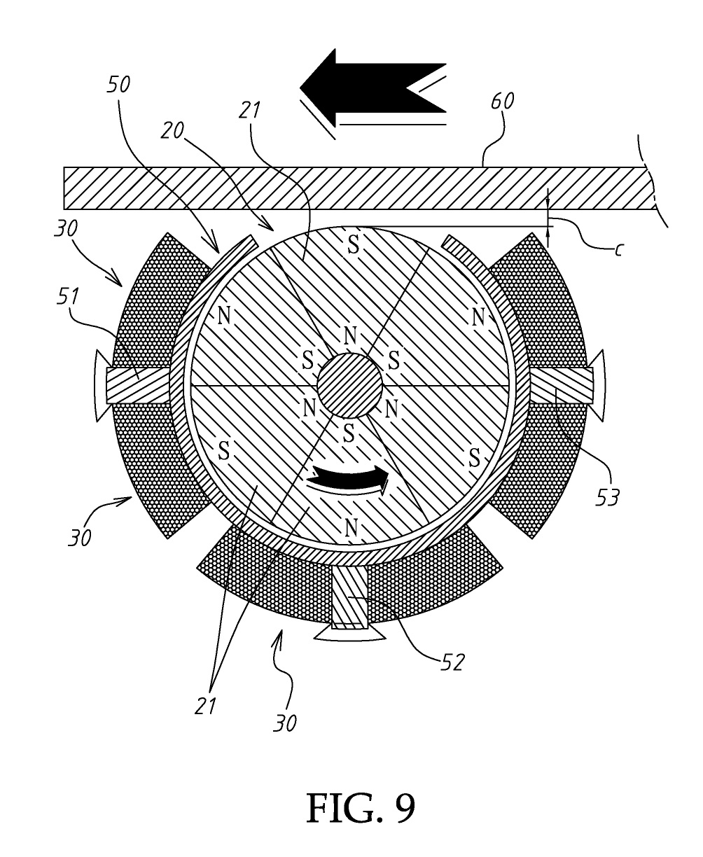

FIG. 9 illustrates an induction generator in accordance with a first embodiment of the present invention. According to this first embodiment, the induction generator comprises a rotor 20 formed of a plurality of magnets 21, a stator 50 that is disposed around the rotor 20 and comprises a plurality of partition walls 51˜53 equiangularly spaced around the rotor 20, and a plurality of coil windings 30 respectively wound round the partition walls 51˜53 in a non-coaxial manner relative to one another. Further, a mating member 60 made of a magnetic permeable material is disposed in proximity to the rotor 20, the stator 50 and the coil windings 30 in a contactless manner for movement relative to the rotor 20 so that rotating of the rotor 20 can cut across magnetic lines of force to generate the desired voltage and current.

In the following various alternate forms, the reference numbers of the rotor 20, magnets 21, coil windings 30 and stator partition walls 51˜53 remain unchanged, i.e., like reference numbers denote like component parts.

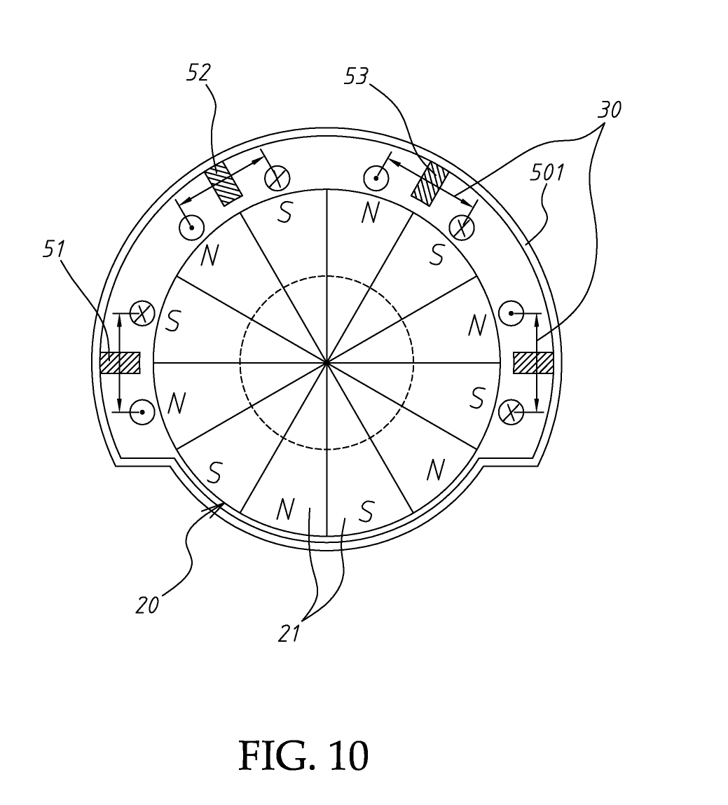

FIG. 10 illustrates an induction generator in accordance with a second embodiment of the present invention. According to this second embodiment, the induction generator comprises a rotor 20 formed of a plurality of magnets 21, a roil winding rack 51 that functions as a stator and comprises a plurality of partition walls 51˜53 equiangularly spaced around an inner perimeter thereof around the rotor 20, and a plurality of coil windings 30 respectively wound round the partition walls 51-53 of the roil winding rack 51 in a non-coaxial manner relative to one another.

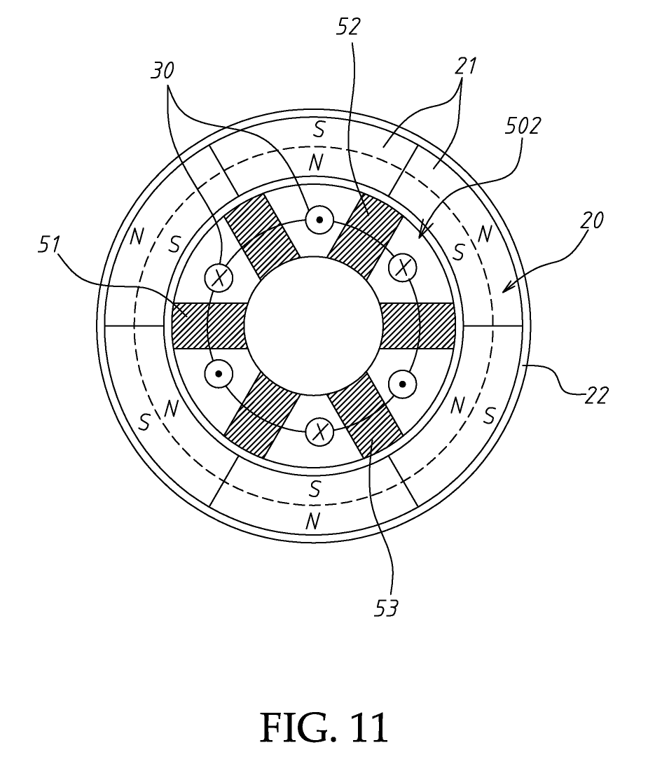

FIG. 11 illustrates an induction generator in accordance with a third embodiment of the present invention. According to this third embodiment, the induction generator comprises an annular outer rotor 20 that comprises a plurality of magnets 21 abutted against one another around a circle with the polar direction of each two adjacent magnets revered to each other and an outer race 22 surrounding the magnets 21, an inner positioning member 502 that is mounted in the center hole defined in the outer rotor 20 and surrounded by the magnets 21 and comprises a plurality of equiangularly spaced and radially extended partition walls 51-53, and a plurality of coil windings 30 respectively wound round the partition walls 51-53 of the roil winding rack 51 in a non-coaxial manner relative to one another.

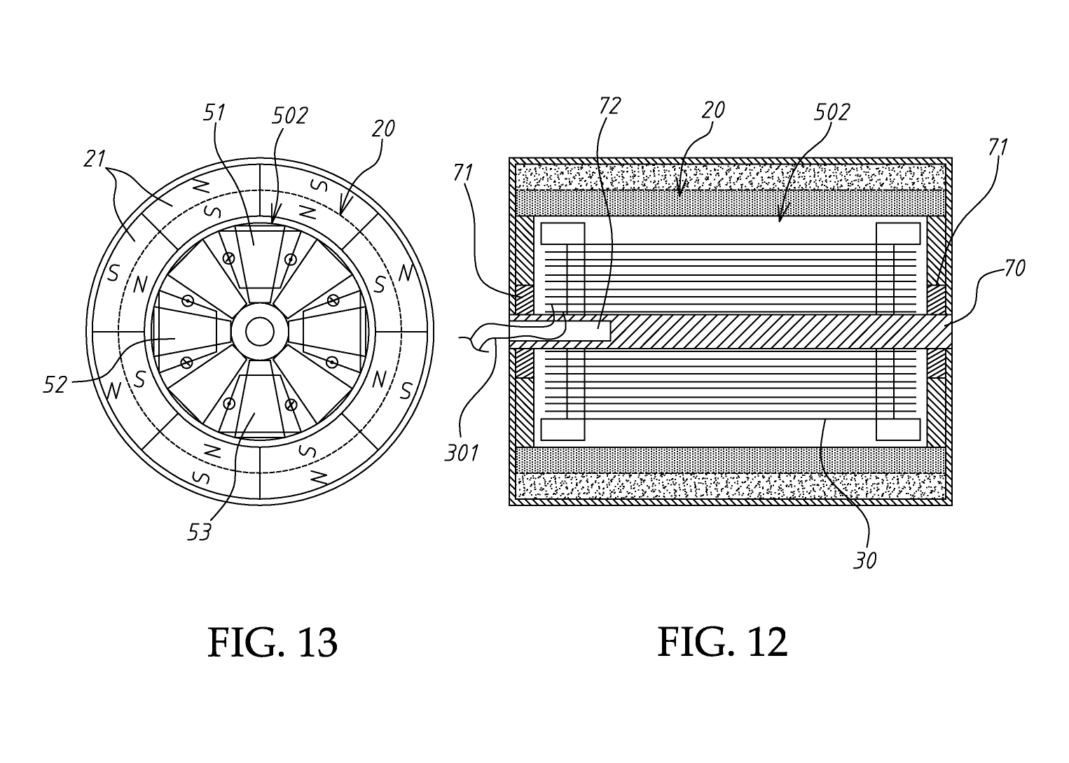

FIGS. 12 and 13 illustrate an induction generator in accordance with a fourth embodiment of the present invention. This fourth embodiment is substantially similar to the aforesaid third embodiment with a shaft 70 is axially mounted in the center hole defined in the outer rotor 20 and surrounded by the inner positioning member 502 that is surrounded by the magnets 21 of the outer rotor 20. Similar to the aforesaid third embodiment, the positioning member 502 also comprises a plurality of partition walls 51-53 that are equiangularly spaced around the shaft 70 for the winding of coil windings 30. Further, the shaft 70 works as the axis of motion of the rotor 20, having a bearing 71 mounted at each of two opposite ends thereof and a wire hole 72 for enabling lead wires 301 of the coil windings 30 to be extended to the outside.

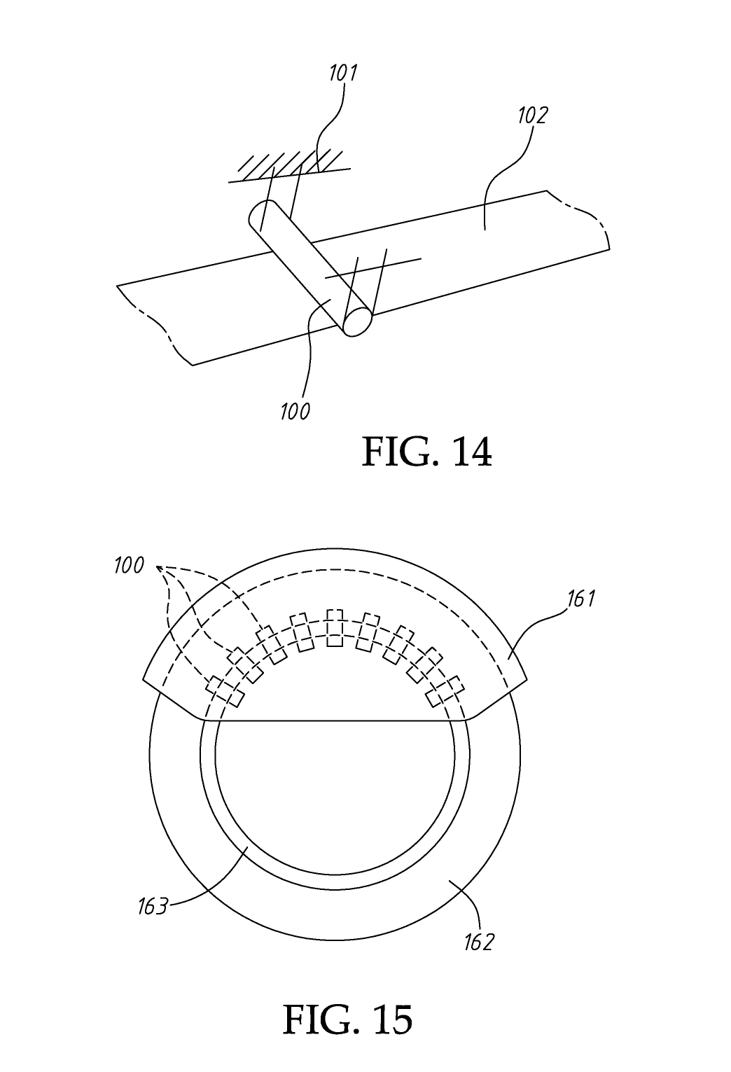

FIG. 14 illustrates an induction generator in accordance with a fifth embodiment of the present invention. According to this fifth embodiment, the induction generator 100 is shaped like a strip mounted at the bottom side of a carriage 101 of a train or tram near the rail 102.

FIG. 15 illustrates an induction generator in accordance with a sixth embodiment of the present invention. According to this sixth embodiment, multiple induction generators 100 are mounted in the wheel well of a fender 161 of a magnetic permeability material near a wheel rim 163 of a wheel 162 of an electric motor vehicle. These induction generators 100 are electrically connected in parallel for recharging the battery of the electric motor vehicle.

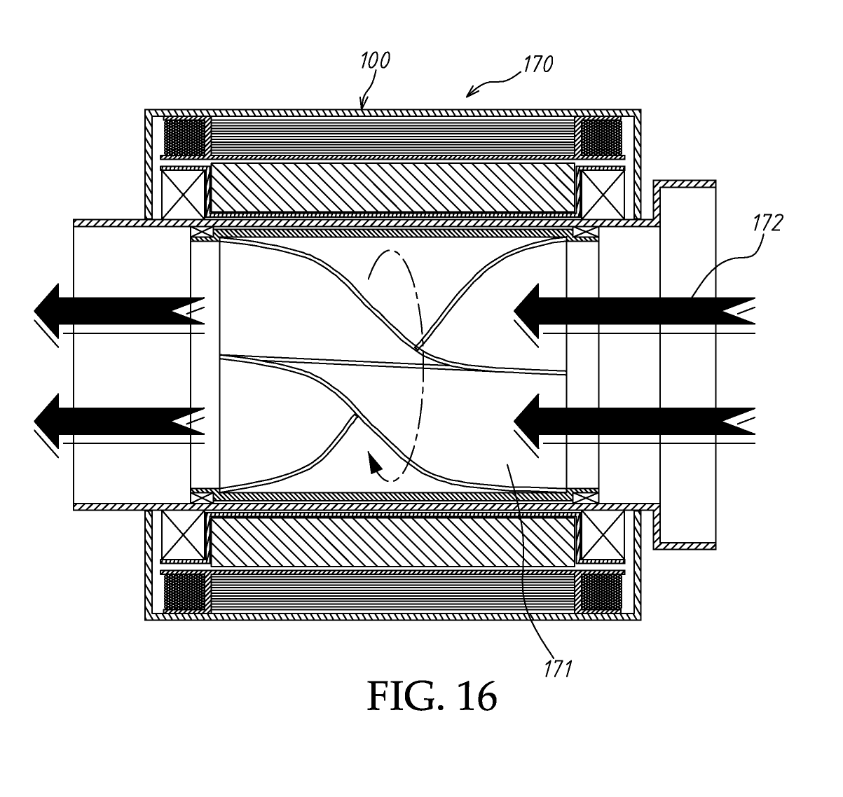

FIG. 16 illustrates a seventh embodiment of the present invention. According to this seventh embodiment, multiple induction generators 100 are mounted in a hydroelectric power generation equipment 170 around a vane 171. When the vane 171 is forced by a flowing flow of water 172 to rotate on its own axis, the induction generators 100 are induced to generate electricity.

The design of induction generator of the present invention allows coil windings of different winding structures to be selectively used and installed to fit different application requirements, effectively improving the induced voltage and current, accelerating power transmission speed in high power consumption devices, and increasing the range of non-contact power equipment applications. The improved design of induction generator of the present invention allows the use of cheap magnets without affecting its performance, therefore, the cost of the induction generator can be significantly reduced.

Although particular embodiments of the invention have been described in detail for purposes of illustration, various modifications and enhancements may be made without departing from the spirit and scope of the invention. Accordingly, the invention is not to be limited except as by the appended claims.

1. An induction generator, comprising:
a rotor rotatable relative to a predetermined magnetic permeability material subject to the effect of magnetic attractive force, said rotor comprising a plurality of magnets, each said magnet having opposing N pole and S pole;
a positioning member radially located around an outer periphery of said rotor, said positioning member comprising a plurality of equiangularly spaced partition walls;
a plurality of coil windings wound around said partition walls of said positioning member in a non-coaxial manner relative to one another;
a direction of an instantaneous current obtained subject to a winding direction of said coil windings and a direction of a magnetic field of said rotor; and
wherein each said coil winding is configured to have an end portion of the instantaneous current input and an end portion of the instantaneous output of the coil winding respectively located on opposing ends of each said coil winding, for each coil winding a direction of the instantaneous current at the opposing ends being in opposite directions, each said coil winding is also configured to have each wire segment thereof extending downward relative to one of the N pole and the S pole of each said magnet and upward relative to the other of the N pole and the S pole of each said magnet;
wherein said coil windings have one single wire that is wound around one said partition wall being one said coil winding and then wound around another said partition wall being another said coil winding and then wound around the other said partition walls being the other said coil windings in proper order.

2. (canceled)

3. An induction generator, comprising:
a rotor rotatable relative to a predetermined magnetic permeability material subject to the effect of a magnetic attractive force, said rotor comprising a plurality of magnets, each said magnet having opposing N pole and S pole;
a positioning member radially located around an outer periphery of said rotor, said positioning member comprising a plurality of equiangularly spaced partition walls;
a plurality of coil windings wound around said partition walls of said positioning member in a non-coaxial manner relative to one another;
a direction of an instantaneous current obtained subject to a winding direction of said coil windings and a direction of a magnetic field of said rotor; and
wherein each said coil winding is configured to have an end portion of the instantaneous current input and an end portion of the instantaneous output of the coil winding respectively located on opposing ends of each said coil winding, for each coil winding a direction of the instantaneous current at the opposing ends being in opposite directions, each said coil winding is also configured to have each wire segment thereof extending downward relative to one of the N pole and the S pole of each said magnet and upward relative to the S the other of the N pole and the S pole of each said magnet;
wherein said coil windings have one single wire that is wound around said partition walls in a proper order through one turn, and then repeatedly wound around said partition walls in a proper order through another one turn, and repeatedly wound around said partition walls in the same manner till that said coil windings are respectively formed on said partition walls.

4. The induction generator as claimed in claim 1, wherein the winding directions of each two adjacent said coil windings are reversed to each other.

5. The induction generator as claimed in claim 1, wherein said positioning member is an annular stator disposed around said rotor, said partition walls are spaced around an outer perimeter of said annular stator and adapted to hold said coil windings in a non-coaxial manner relative to one another.

6. The induction generator as claimed in claim 1, wherein said positioning member is a coil winding rack arranged around said rotor, said partition walls are equiangularly spaced around an inner perimeter of said coil winding rack and adapted to hold said coil windings in a non-coaxial manner relative to one another.

7. The induction generator as claimed in claim 1, wherein said magnets of said rotor are abutted against one another around a circle, defining therein a center hole; said positioning member is mounted in the center hole defined in said rotor and surrounded by said magnets, having the partition walls thereof arranged in an equiangularly spaced and radially extended relationship to hold said coil windings in a non-coaxial manner relative to one another.

8. The induction generator as claimed in claim 7, wherein said rotor comprises a shaft disposed at the center thereof, said shaft comprising a wire hole for enabling the current input lead wire and current output lead wires of said coil windings to be extended to the outside.

9. The induction generator as claimed in claim 1, which is shaped like a strip and mounted at a bottom side of a carriage of a train near a rail on which said train is running.

10. The induction generator as claimed in claim 1, which allows multiple induction generators of the same structure to be mounted in a wheel well of a fender of a magnetic permeability material near a wheel rim of a wheel of an electric motor vehicle, and electrically connected in parallel for recharging a battery of said electric motor vehicle.

11. The induction generator as claimed in claim 1, which is mounted in a hydroelectric power generation equipment around a vane.

12. The induction generator as claimed in claim 3, wherein the winding directions of each two adjacent said coil windings are reversed to each other.

13. The induction generator as claimed in claim 3, wherein said positioning member is an annular stator disposed around said rotor, said partition walls are spaced around an outer perimeter of said annular stator and adapted to hold said coil windings in a non-coaxial manner relative to one another.

14. The induction generator as claimed in claim 3, wherein said positioning member is a coil winding rack arranged around said rotor, said partition walls are equiangularly spaced around an inner perimeter of said coil winding rack and adapted to hold said coil windings in a non-coaxial manner relative to one another.
